(19) United States
(12) Patent Application Publication
(10) Pub. No.: US 2008/0056701 A1
(43) Pub. Date: Mar. 6, 2008

(54) Systems and methods of automatically selecting a focus range in cameras

(76) Inventors: John Mick, Fort Collins, CO (US); Gregory Hofer, Fort Collins, CO (US); Jason Yost, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/511,731

(22) Filed: Aug. 29, 2006

(51) Int. Cl. G03B 13/00

(52) U.S. Cl. 396/125

(57) ABSTRACT

Systems and methods of automatically selecting a focus range in cameras are disclosed. In an exemplary implementation, a method for selecting a focus range to auto-focus a camera may include receiving focus data for different lens positions in a first focus range. The method may also include analyzing the focus data from the first focus range for focus data extending from the first focus range into at least a second focus range. The method may also include auto-focusing a camera lens using focus data in the first focus range if no focus data extends from the second focus range into the first focus range. The method may also include auto-focusing the camera lens using focus data in the second focus range if focus data in the second focus range extends into the first focus range.

### BACKGROUND

A wide variety of cameras are commercially available with auto-focus mechanisms. Typical auto-focus operations involve taking a focus-frame at a first lens position, searching the focus-frame for edges (or other focus metrics) in the scene being photographed, and then repeating each step at different lens positions. A higher number of edges (or analysis of another focus metric) indicates that the scene is in focus, and the corresponding lens position is used to take the actual image. Although the entire focus range (i.e., from near the camera lens to infinity) can be used to auto-focus the camera, doing so is processor-intensive and increases the time it takes for a user to take a photograph of the scene.

In order to speed-up the time it takes to auto-focus the camera, some cameras allow the user to select between different focus modes. For example, a normal focus mode may be used for focusing on subjects in the scene that are a “normal” distance from the camera lens (e.g., about 0.5 meters or farther from the camera lens). A macro focus mode may be used for focusing on subjects in the scene that are “close-Lip” to the camera lens (e.g., within about 0.5 meters of the camera lens). Hence, the auto-focus algorithm only has to gather and analyze focus-frame data within the selected range. However, the camera user may not understand the difference between these focus modes and/or may forget to select the appropriate focus mode, frustrating the user when the scene being photographed is not in focus.

### BRIEF DESCRIPTION OF THE DRAWINGS

FIG. 1 is a block diagram of an exemplary camera system which may be implemented to automatically select a focus range.

FIG. 2 is a high-level illustration of a camera focusing on a target in a scene being photographed and corresponding focus data, wherein the target is in a first focus range.

FIG. 3 is a high-level illustration of a camera focusing on a target in a scene being photographed and corresponding focus data, wherein the target is in a second focus range.

FIG. 4 is a high-level illustration of a camera focusing on a target in a scene being photographed and corresponding focus data, wherein the target is in a second focus range and another target is in a first focus range.

FIG. 5 is a flowchart illustrating exemplary operations which may be implemented for automatically selecting a focus range in cameras.

### DETAILED DESCRIPTION

Systems and methods are disclosed for automatically selecting a focus range in cameras. In an exemplary embodiment, firmware may be provided in the camera for analyzing a scene being photographed. The camera may be used to take a focus-frame, e.g., an image capture having a predetermined region size, subsampling, and/or binning attributes for focus analysis. Then firmware analyzes the focus-flame data in a first focus range. If the focus-frame data in the first focus range does not indicate there are any targets in a second focus range, the focus-frame data in the first focus range is used to auto-focus the camera. If, however, the focus-fame data in the first focus range indicates that there may be at least one target in the second focus range, the firmware then analyzes focus-frame data in the second focus range. The focus-frame data in the second focus range may then be used to auto-focus the camera.

In exemplary embodiments, the firmware may determine whether to proceed to the second focus range based only on analyzing focus-frame data from the first focus range. Focus-frame data does not need to be gathered and analyzed in the second focus range if analyzing the focus-frame data in the first focus range indicates that there are no targets in the second focus range. Accordingly, the firmware may speed up the time it takes to auto-focus the camera by only analyzing focus-frame data in the second focus range on an as-needed basis.

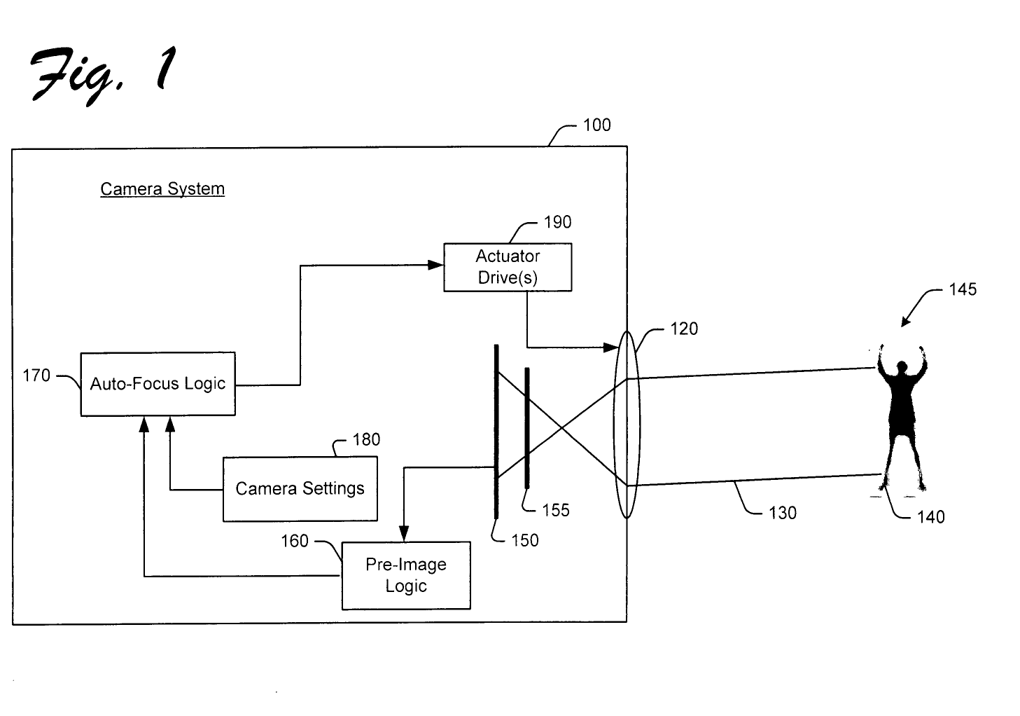

FIG. 1 is a block diagram of an exemplary camera system 100 which may be implemented to automatically select a focus range. The exemplary camera system 100 may be a still-photo and/or video camera, now known or that may be later developed.

Exemplary camera system 100 may include a lens 120 positioned to focus light 130 reflected from one or more objects 140 in a scene 145 onto an image sensor 150 when a shutter 155 is open (e.g., for image exposure). It is noted that a separate image sensor (not shown) may also be provide, e.g., dedicated to focus operations. Exemplary lens 120 may be any suitable lens which focuses light 130 reflected from the scene 145 onto image sensor 150.

Exemplary image sensor 150 may be implemented as a plurality of photosensitive cells, each of which builds-up or accumulates an electrical charge in response to exposure to light. The accumulated electrical charge for any given pixel is proportional to the intensity and duration of the light exposure. Exemplary image sensor 150 may include, but is not limited to, a charge-coupled device (CCD), or a complementary metal oxide semiconductor (CMOS) sensor.

Camera system 100 may also include focus-frame logic 160. In digital cameras, the focus-frame logic 160 receives electrical signals from the image sensor 150 representative of the light 130 captured by the image sensor 150 during exposure to generate a digital focus-frame of the scene 145.

Using a focus-frame enables the camera system to perform various processes (e.g., auto-exposure, auto-focus, image stabilizing, detecting white balance, etc.). The focus-frame(s) may be one or more of the focus-frames already being implemented by the camera for focusing, auto-exposure, pre-flash calculations, and/or the focus-frame(s) may be obtained specifically for displaying to the user.

Camera system 100 may also include auto-focus logic 170. Auto-focus logic 170 may receive the focus-frame data from focus-frame logic 160 and perform various calculations or processes on the focus-frame data. Exemplary auto-focus logic 170 may implement processes for automatically selecting a focus range for auto-focus operations, such as described in more detail below.

Auto-focus logic 170 may receive input from other sources in addition to the focus-frame logic 160. For example, camera settings data 180 may also be provided as input to the auto-focus logic 170. Output from the auto-focus logic 170 may be used by one or more other program code modules in the auto-focus logic 170 and/or by auto-focus mechanisms (e.g., actuator drives 190 for moving the lens 120 into focus).

Before continuing, it is noted that shutters, image sensors, and other devices, such as those illustrated in FIG. 1 and others not shown but that are common to cameras, are well-understood in the camera and photography arts. These components may be readily provided for camera system 100 by those having ordinary skill in the art after becoming familiar with the teachings herein, and therefore further description is not necessary.

It is also noted that the camera system 100 shown and described above with reference to FIG. 1 is merely exemplary of a camera system which may be implemented to automatically select a focus range. The systems and methods described herein are not intended to be limited only to use with the camera system 100. Other embodiments of camera systems are also contemplated which may be implemented to automatically select a focus range.

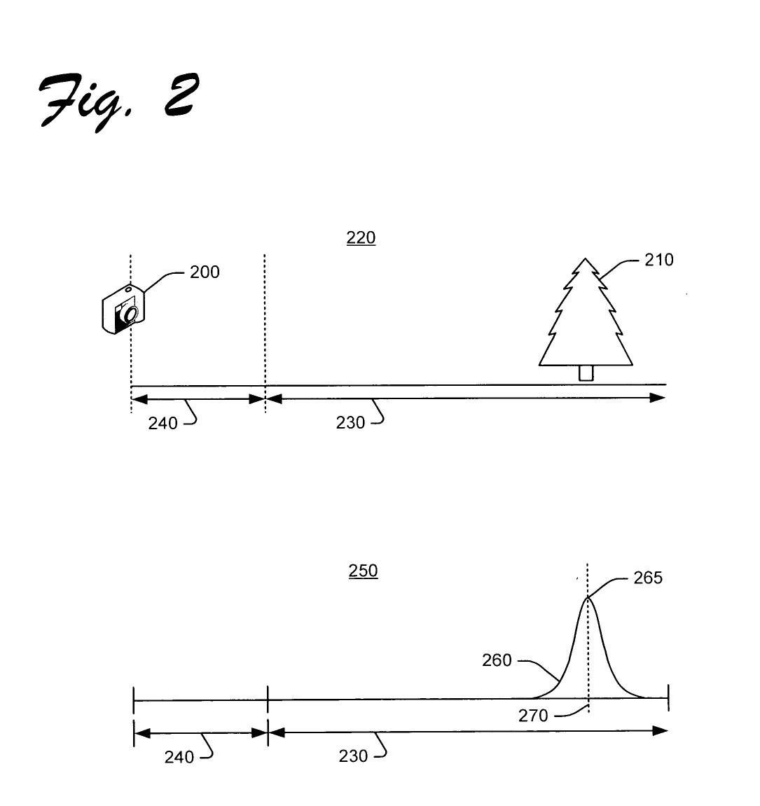

FIG. 2 is a high-level illustration of a camera 200 (e.g., the camera system 100 shown in FIG. 1) focusing on a target 210 in a scene 220 being photographed and a plot 250 of corresponding focus data 260. In FIG. 2, the target 210 used for auto-focus operations is in a first focus range 230 and no targets are in the second focus range 240. It is noted that the target 210 used for auto-focus operations is typically a high-contrast object in the scene being photographed. The target 210 may or may not be the same as the subject of the scene 220 being photographed.

In this example, the auto-focus operations begin by retrieving focus data 260 from the first focus range 230. The camera lens may be moved to a first lens position in the first focus range 230 for taking a focus-frame, and the focus-frame may be searched for number of edges (or other focus metrics). The camera lens may then be moved to another lens position for taking another focus-frame, and so forth. The focus data 260 is then compiled and analyzed to identify a lens position corresponding to an area of high contrast. For example, the peak 265 illustrated graphically in FIG. 2 indicates an area of high contrast from the target 210.

In this example, no focus data from the second focus range 240 extends into the first focus range 240. Accordingly, auto-focus operations do not need to continue to retrieve focus data from the second focus range 240, and the lens position 270 corresponding to the peak 265 may be used to focus the camera 200 on the target 210.

Before continuing, it should be understood that the focus data 260 is illustrated graphically in FIG. 2 by plot 250 to aid in understanding this example. However, the focus data does not need to be presented graphically (e.g., as shown in FIG. 2 by plot 250) when implemented by the camera system. Indeed, the focus data may be stored in any suitable data structure in the camera's memory for use in the auto-focus operations (e.g., by auto-focus logic 170 in FIG. 1).

It is noted that the first focus range 230 may be the so-called “normal” focus range (e.g., beyond about 0.5 meters of the camera lens), and the second focus range 240 may be the so-called “macro” focus range (e.g., within about 0.5 meters of the camera lens). However, the systems and methods described herein are not limited to any particular definition of the first and second focus ranges.

It is also noted that the systems and methods described herein are not limited to use with any particular number of focus ranges. In other embodiments, the systems and methods may also be implemented with three or more focus ranges. For example, focus data may be retrieved for a focus range which is determined to be the typical focus range. A typical focus range may be based on the habits of a majority of camera users, or the habits of particular sub-sets of users (e.g., those who use their cameras primarily indoors, or those who use their cameras primarily outdoors). The typical focus range may also be based on the habits of a particular camera user determined over time as the camera is used. In any event, focus data may then be retrieved for one or more adjacent focus range if focus data extends from this typical focus range into one or more of the adjacent focus ranges.

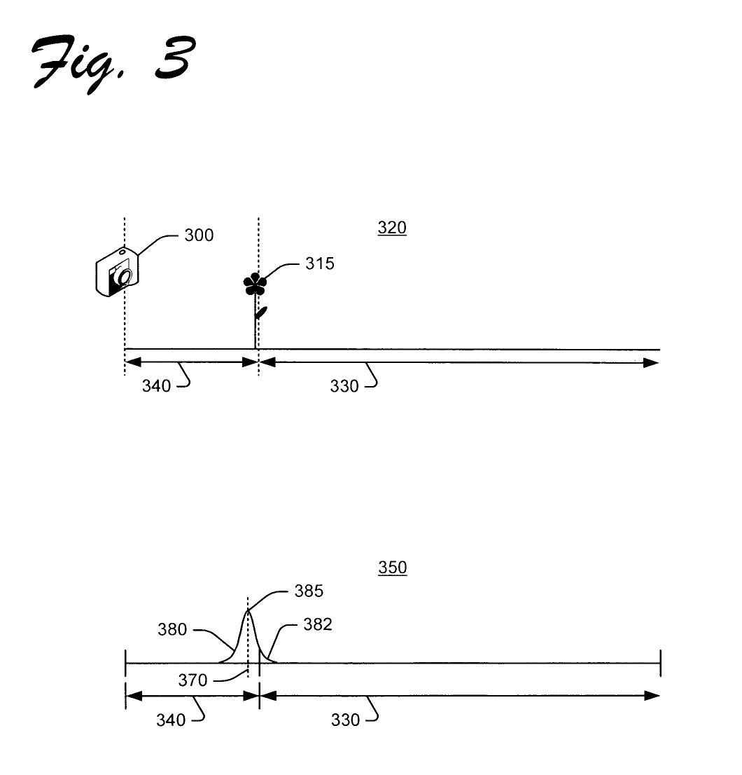

FIG. 3 is a high-level illustration of a camera 300 focusing on a target 315 in a scene 320 being photographed. Corresponding focus data 360 is shown in plot 350. In this example, the target 315 is in a second focus range 340 and there are no targets in the first focus range 330. Before continuing, it is noted that 300-series reference numbers are used to refer to similar components in FIG. 2, and that these components may not necessarily be described again with regard to FIG. 3.

In this example, the auto-focus operations begin by retrieving focus data 360 from the first focus range 330, as described above with reference to FIG. 2. The focus data from the first focus range 330 is then compiled and analyzed. Analysis indicates that there may be focus data from a second focus range extending into the first focus range 340 (i.e., tail 382 of the focus data 380 curve). Accordingly, the auto-focus operations may continue by retrieving focus data 380 from the second focus range 340. Analyzing the focus data 380 from the second focus range 340 indicates a peak 385 corresponding to an area of high contrast from the target 315. Accordingly, the lens position 370 corresponding to the peak 385 may be used to focus the camera 300 on the target 315.

The tail of the focus data curve 380 may extend substantially further from the center of the peak 385 than illustrated so that even when a peak occurs at the far left end of the second focus range 340 (e.g., an object is very close to the camera), the tail of the focus peak will still extend into the first focus range 330. There are various filtering techniques that can be used on the focus data that are common to those practiced in the art to control the width of the peak and the amount of the extent of the tail.

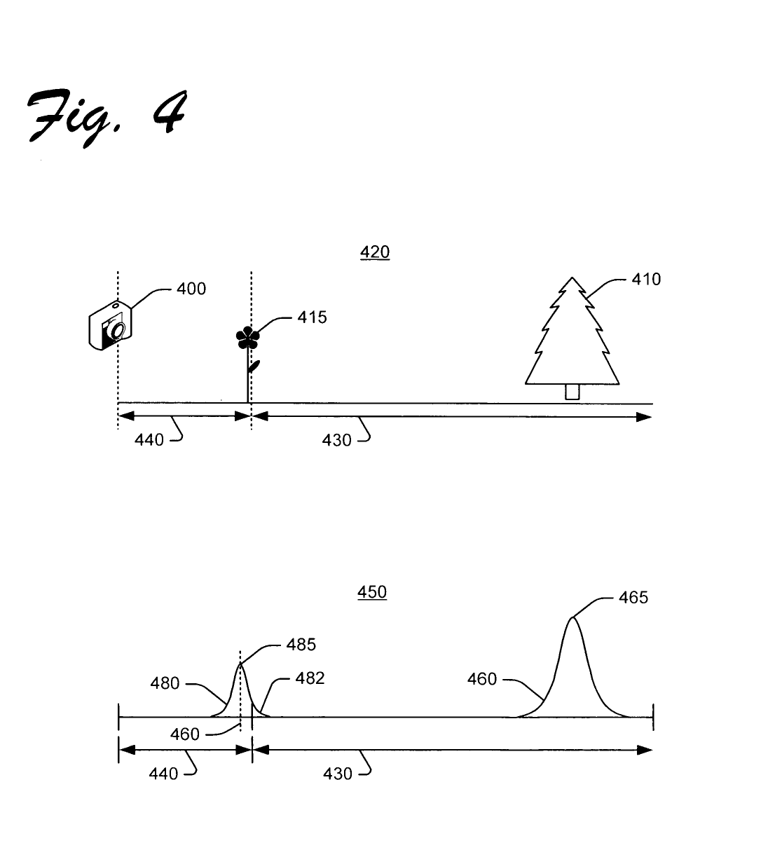

FIG. 4 is a high-level illustration of a camera 400 focusing on a target 415 in a scene 420 being photographed. Corresponding focus data 460 and 480 is shown in plot 350. In this example, the target 415 is in a second focus range 445, but there is also an object 410 that may be a suitable target in the first focus range 430. Before continuing, it is noted that 400-series reference numbers are used to refer to similar components in FIG. 2, and that these components may not necessarily be described again with regard to FIG. 4.

In this example, the auto-focus operations begin by retrieving focus data 460 from the first focus range 430, as described above with reference to FIG. 2. The focus data from the first focus range 430 is then compiled and analyzed. Analysis indicates that there may be focus data from a second focus range extending into the first focus range 440 (i.e., tail 482 of the focus data 480 curve). Accordingly, the auto-focus operations may continue by retrieving focus data 480 from the second focus range 440. Analyzing the focus data 380 from the second focus range 340 indicates a peak 485 corresponding to an area of high contrast from the target 415.

Experimental data suggests that when there is a suitable target in the second focus range 440, the user intends to focus on this target even if there are other objects that may be suitable targets in the first focus range 430. Therefore, in an exemplary embodiment, the lens position 470 corresponding to the peak 485 may be used to focus the camera 400 on the target 415 even if there is another peak 465 in the first focus range 430.

In other embodiments, however, the lens position 470 corresponding to the peak 485 may be used to focus the camera 400 on the target 415 only if the focus data 480 in the second focus range 440 is substantially better than the focus data 460 in the first focus range 430. For example, focus data 480 from the second focus range 440 may be unacceptable for focusing the camera lens.

Although the terms “substantially better” and “unacceptable” are relative terms, the definition of these terms can be readily defined by those having ordinary skill in the camera arts based at least in part on various design considerations and/or the expectations of the user(s). These definitions may then be implemented in the firmware, for example, as a threshold. That is, the focus data 480 from the second focus range 440 may be unacceptable (or the focus data 460 from the first focus range 430 may be substantially better) if the threshold is satisfied. For purposes of illustration, the threshold may be defined as a minimum peak height and/or peak width. Other suitable metrics may also be used for defining a threshold value, as will be readily appreciated by those having ordinary skill in the art after becoming familiar with the teachings herein.

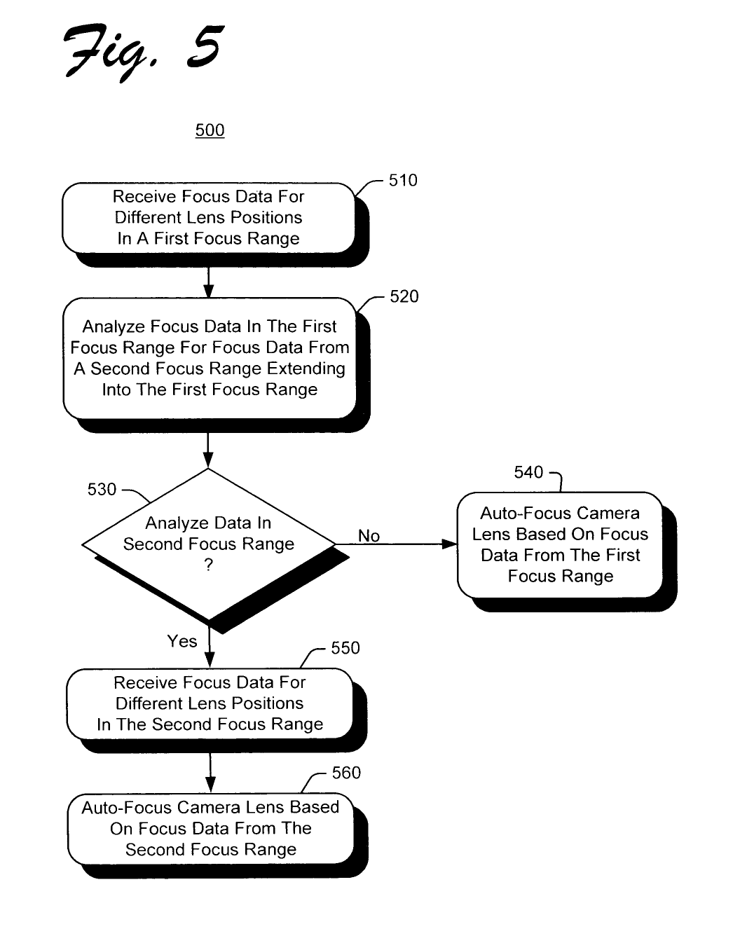

FIG. 5 is a flowchart illustrating exemplary operations which may be implemented for automatically selecting a focus range in cameras. The operations 500 may be embodied as logic instructions on one or more computer-readable medium. When executed by a processor, the logic instructions implement the described operations. In an exemplary implementation, the components and connections depicted in the figures may be used for automatically selecting a focus range in cameras.

In operation 510, focus data is received for different lens positions in a first focus range. For example, the camera lens may be moved to a first lens position in the first focus range for taking a focus-frame, and the focus-frame may be searched for number of edges (or other focus metrics). The camera lens may then be moved to another lens position for taking another focus-frame, and so forth. In operation 520, the focus data is analyzed from the first focus range for focus data from a second focus range extending into the first focus range.

In operation 530, a determination is made whether to analyze focus data from the second focus range. For example, focus data may be analyzed from the second focus range only if analyzing the focus data in the first focus range indicates that there is evidence of a target in the second focus range. There may be a target in the second focus range if focus data in the second focus range extends into the first focus range.

If no focus data extends into the first focus range from the second focus range, it is assumed that that there are no targets in the second focus range and the camera lens may be auto-focused using focus data in the first focus range in operation 540. In an exemplary embodiment, no focus data is retrieved from the second focus range to speed up the auto-focus operations.

If focus data from the second focus range extends into the first focus range, in operation 550 focus data is then received for different lens positions in the second focus range. In operation 560, the camera lens may be auto-focused using focus data in the second focus range. In an exemplary embodiment, focus data from the first focus range may instead be used for the auto-focus operations if focus data from the second focus range is unacceptable for focusing the camera lens. For example, focus data from the first focus range may be used if the focus data from the second focus range does not meet a predetermined threshold (e.g., minimum peak height).

The operations shown and described with reference to FIG. 6 are provided to illustrate exemplary embodiments for automatically selecting a focus range in cameras. It is noted that the operations are not limited to the ordering shown. Still other operations may also be implemented.

It is noted that the exemplary embodiments shown and described are provided for purposes of illustration and are not intended to be limiting. Still other embodiments are also contemplated for automatically selecting a focus range in cameras.

1. A method for selecting a focus range to auto-focus a camera, comprising:
receiving focus data for different lens positions in a first focus range;
analyzing the focus data from the first focus range for focus data extending from at least a second focus range;
auto-focusing a camera lens using focus data in the first focus range if no focus data extends from the second focus range into the first focus range; and
auto-focusing the camera lens using focus data in the second focus range if focus data in the second focus range extends into the first focus range.

2. The method of claim 1 further comprising only analyzing the focus data in the second focus range if analyzing the focus data from the first focus range indicates focus data extending into the first focus range from a second focus range.

3. The method of claim 1 further comprising auto-focusing the camera lens using focus data in the first focus range even when focus data in the second focus range extends into the first focus range if focus data from the second focus range is unacceptable for focusing the camera lens.

4. The method of claim 3, wherein focus data from the first focus range is used for focusing the camera lens if the focus data from the second focus range does not meet a predetermined threshold.

5. The method of claim 3, wherein focus data from the second focus range is unacceptable for focusing the camera lens if the focus data from the first focus range is substantially better than the focus data from the second focus range.

6. The method of claim 1 wherein the second focus range is directly adjacent to the first focus range.

7. The method of claim 1 further comprising determining a typical focus range based on user habits, wherein the first focus range is the typical focus range.

8. A camera system comprising:
a camera lens operable to move between different lens positions in at least a first focus range and a second focus range;
focus-frame logic executable to generate focus data corresponding to the different lens positions of the camera lens;
auto-focus logic executable to analyze the focus data from the focus-frame logic in the first focus range and determine if any focus data extends from the second focus range into the first focus range; and
an auto-focus mechanism using focus data in the second focus range to auto-focus the camera lens only if the focus data extends from the second focus range into the first focus range.

9. The camera system of claim 8 wherein the auto-focus mechanism uses focus data in the first focus range to auto-focus the camera lens if no focus data extends from the second focus range into the first focus range.

10. The camera system of claim 8 wherein the auto-focus mechanism uses focus data in the first focus range to auto-focus the camera lens even if focus data extends from the second focus range into the first focus range.

11. The camera system of claim 8 wherein the auto-focus mechanism uses focus data in the first focus range to auto-focus the camera lens if focus data in the second focus range is unacceptable for focusing the camera lens.

12. The camera system of claim 11, wherein focus data from the second focus range is unacceptable for focusing the camera lens if the focus data from the second focus range does not meet a predetermined threshold.

13. The camera system of claim 11, wherein focus data from the second focus range is unacceptable for focusing the camera lens if the focus data from the first focus range is higher quality than the focus data from the second focus range.

14. The camera system of claim 8, wherein the first focus range is a normal-focus range.

15. The camera system of claim 8, wherein the first focus range is a typical focus range for a majority of camera users.

16. The camera system of claim 8, wherein the first focus range is a typical focus range for a particular user of the camera system.

17. The camera system of claim 8, wherein the second focus range is a macrofocus range.

18. A camera system for automatically selecting a focus range, comprising:
means for retrieving focus data corresponding to different positions of a camera lens in a first focus range and a second focus range;
means for determining if any focus data extends from the second focus range into the first focus range based only on focus data retrieved in the first focus range; and
means for focusing the camera lens using focus data in the second focus range only if the focus data in the second focus range extends into the first focus range.

19. The camera system of claim 18 further comprising means for rejecting the focus data in the second focus range if the focus data is unacceptable for focusing the camera lens.

20. The camera system of claim 18 wherein the means for retrieving focus data only retrieves focus data from the second focus range if the focus data in the second focus range extends into the first focus range.
